(19) United States
(12) Patent Application Publication
(10) Pub. No.: US 2018/0084734 A1
(43) Pub. Date: Mar. 29, 2018

(54) SELF-SUPPORTING FABRIC POT AND METHOD OF MANUFACTURING THE SAME

(71) Applicant: High Caliper Growing, Inc., Oklahoma City, OK (US)

(72) Inventors: Kurt E. Reiger, Oklahoma City, OK (US); Mark Evans, Conover, NC (US); Randy Bruinsma, Morganton, NC (US)

(21) Appl. No.: 15/278,883

(22) Filed: Sep. 28, 2016

(51) Int. Cl. A01G 9/02; A01G 9/10

(52) U.S. Cl. CPC A01G 9/02; A01G 9/1006

(57) ABSTRACT

A self-supporting fabric container is provided. The container can be made of a fabric that has binder and base fibers. The container can be manufactured by forming a container shaped from a production fabric and heating the production fabric to a temperature between the melting points of the base and binder fibers. The product fabric is cooled thereafter to form a rigid, self-supporting fabric pot.

The present disclosure relates to fabric pots and a method of manufacturing such pots.

### BACKGROUND

Nurseries and other plant growers use a variety of methods for growing plants. Growing in containers is exceedingly common. Nursery containers are most often made of plastic. Ceramic, tin and pressed peat are also used to make nursery containers. All of these containers are hard sided. Hard-sided containers are easy to move and transport. They are easy to stack and are easy to run through an automated filler machine on a conveyer belt where the soil medium is dumped into the rigid container without damaging or affecting the rigid container. Almost all rigid containers are non-air permeable and non-water permeable. The only air and water permeable areas are the open top and the various drain holes that may be cut into the bottom or lower sides of the rigid container. The root structures of plants grown in rigid, non-permeable containers will circle, resulting in a poor quality plant when transplanted, and in certain cases the death of the plant. Drainage is also a problem in rigid containers because other than drainage holes, such containers are not porous. Hard-sided containers also trap and hold heat, resulting in a growing area too hot for ideal plant growth. One solution to this problem has been the development of soft-sided fabric containers in which plants can be grown above ground. These fabric containers are air and water permeable because they are made of porous fabric. These fabric containers greatly reduce or eliminate root circling. They also release heat buildup in the container and allow moisture movement and evaporation through the container walls.

Traditionally, fabric containers for growing are sewn, glued, or otherwise assembled into their final shape from a number of fabric pieces. The process of cutting, manipulating and sewing the fabric into its final shape adds time, complexity and expense to the process of manufacturing fabric pots. Currently used fabric pots are flexible and not capable of standing upright without an additional support structure. As a result, the use of fabric pots on assembly lines and automatic filling systems in which soil is dropped into individual containers is not feasible. Thus, while fabric pots are useful for growing plants, the flexibility of the fabric results in a pot, or container that will not stand upright to allow auto-filling without additional support. In addition, current fabric containers cannot be stacked without the soft-sided fabric collapsing, greatly limiting the ability of nurserymen to ship plants grown in soft-sided fabric containers. In addition, soft-sided fabric containers are more difficult to move because they do not have a sturdy, rigid top lip that someone can easily grab and move around.

### SUMMARY

The current disclosure is directed to a plant container that comprises a fabric bottom and a fabric sidewall extending upwardly from the fabric bottom. The fabric sidewall is porous and has sufficient rigidity to stand upright. In other words, the plant container will stand without any other supporting structure. As a result, the plant container may stand upright and be used in autofilling or other machines that allow soil or other plant-growing medium to be poured directly into the open top of the plant container.

The plant container may be formed from a single piece of fabric. In other words, the plant container will have no stitching or sewing and will be formed from a single fabric piece. The single fabric piece may be made up of a plurality of base fibers and binder fibers wherein the binder fiber has a lower melting point than the base fiber. The plant container may utilize base fibers selected from the group consisting of polyethylene, polypropylene, polyvinylchloride, polystyrene, polyolefins, polyamide, polyurethane, polyesters and mixtures thereof. In one embodiment the plant container comprises a generally frustoconical shape. The plant container is water and air permeable.

A method for fabricating the rigid fabric container disclosed herein comprises fabricating a generally flat fabric sheet. The container shape with an open top is formed from the fabric sheet. After forming, the method may comprise heating the container shape and then cooling the container shape. Once the container shape is cooled, the method comprises cutting the container shape from the fabric sheet.

The forming step may comprise inserting a portion of the fabric sheet into a mold with a plunger. The plunger is removed after the heating step. The fabric is heated to a temperature between the melting point of the binder fibers and the base fibers. The base fibers have a higher melting point than the binder fibers. If desired, a plurality of plungers may be utilized to simultaneously plunge two or more separate portions of the fabric sheet into at least two molds to form at least two container shapes. The heating, removing, cooling and cutting steps for each container shape may be performed with respect to all container shapes formed.

### BRIEF DESCRIPTION OF THE DRAWINGS

FIG. 1 A is a perspective view of an embodiment of a pot provided by the present disclosure.

FIG. 1B is a top view of one embodiment of a pot provided by the present disclosure.

FIG. 1C is a section view of one embodiment of a pot provided by the present disclosure.

FIG. 2A is a schematic side view of equipment suitable for use in a method of manufacturing a container provided by the present disclosure.

FIG. 2B is a schematic top view of equipment suitable for use in a method of manufacturing a container provided by the present disclosure.

### DETAILED DESCRIPTION

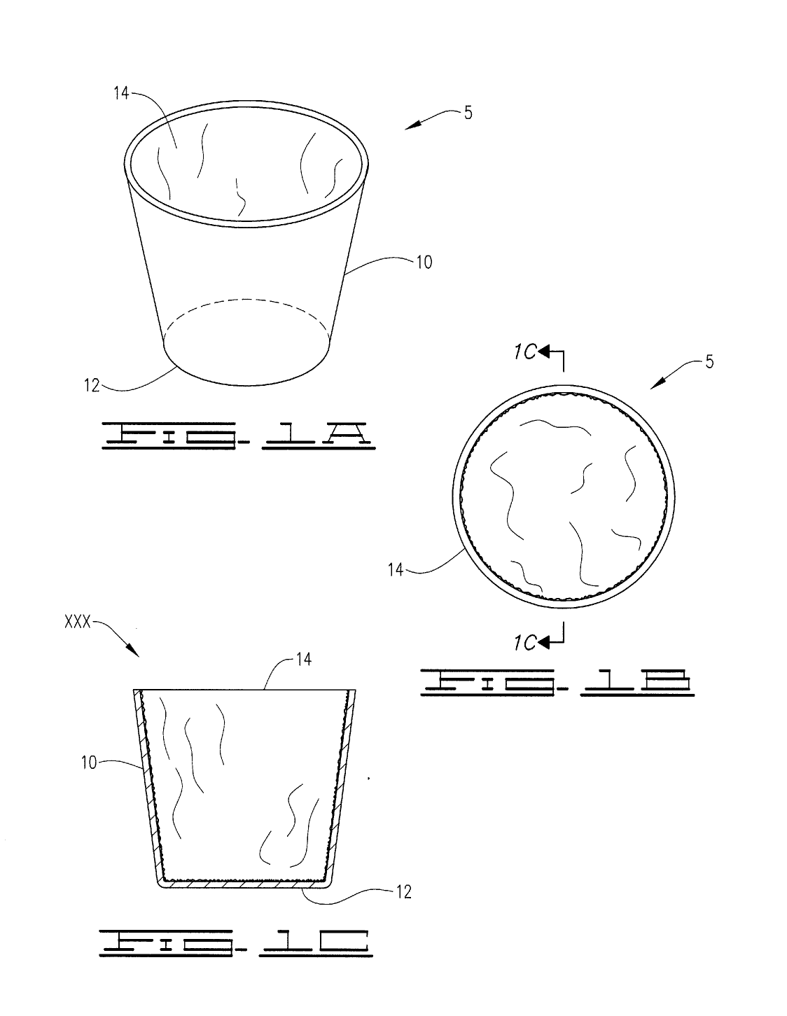

Turning to FIG. 1A, the container, or pot 5 comprises a sidewall 10, a bottom 12, and a top opening 14 defined by sidewall 10. Sidewall 10 has an inner surface 11 that is rough or fuzzy so that it will trap root tips that grow into sidewall 10. Bottom 12 may be a flat, circular bottom. Sidewall 10 slopes inwardly from top opening 14 to bottom 12, so that container 5 is generally frustoconically shaped. Container 5 is a self-supporting container manufactured from a single piece of fabric, with no stitching or sewing and with no external supports or structures. Although a frustoconical shape is shown, container 5 can have any shape suitable for containing soil and plants. For example, container 5 may be cylindrically shaped, triangular, rectangular or any suitable shape for holding soil or other plant growing medium.

Container 5 may be formed from a production fabric 16 that will have sufficient rigidity to stand upright after the manufacturing process is complete. Production fabric 16 is comprised of a plurality of different fibers and, for example, may comprise a combination of a base fiber and a binder fiber. As an example, the base fiber and the binder fiber can be needled together in a nonwoven sheet in which the base fibers have a higher melting point than the binder fiber.

The base fiber may comprise a petroleum-based polymer suitable for use in fabrics. Examples of such polymers include polyethylene, polypropylene, polyvinyl chloride, polystyrene, polyolefin, polyamide, polyurethane, polyester and mixtures thereof. The base fabric may also comprise nylon, rayon or natural fibers. The base fiber is the type of fiber that can be run on a non-woven line and needled into a mat that would have adequate elongation (stretch). The elongation enables the fabric to be molded into a desirable shape.

The binder fiber may be a bi-component polyester or other petroleum-based polymer with a different melting point than the base fiber. Generally, the binder fiber will have a lower melting point than the base fabric. For example, polyester, which may be used as the base fabric has a higher melting temperature than the binder fiber. The melting point for the binder fiber may be, for example, in the range of 110° C. to 180° C. and may be 110° C., 160° C. or 180° C. The temperatures and ranges herein are exemplary and the melting point can be outside the ranges given, so long as the melting point of the binder fiber is lower than the melting point of the base fiber.

The proportions of the base fiber and the binder fiber that comprise the production fabric can vary. For example, the base fiber can comprise about 60 percent of the production fabric and the binder fiber can comprise about 40 percent of the production fabric. The percentages herein are not limiting and are provided only as one example. Different proportions of base to binder fibers may be used depending upon the characteristics of the base and binder fibers. The range ultimately must be such that the resulting container, as described herein, is air and water permeable, and will stand upright with no additional support. In other words the container 5 when complete needs no additional support structure in order to stand upright.

The production fabric is permeable to both water and air, which is beneficial to the health and growth of plants in the fabric containers. The production fabric can have a wide permeability rate with respect to water, for example, in the range of from about ten gallons to one hundred gallons per minute.

While the product fabric is formed from a combination of base and binder fibers, container 5 is a unitary structure. In other words, container 5 is made from a single piece of production fabric 16, and container 5 has no stitching, sewing or stapling.

In the embodiment described, container 5 is self-supporting. As used herein, self-supporting means that the container can stand upright without any additional support. No external supports or structure are used to provide rigidity, all of which is provided by production fabric 16 after the pot 5 is manufactured. The weight of production fabric 16 can vary, and may be, for example, about four ounces to about thirty ounces. The weight may be greater for larger sized containers. For example, a four-ounce fabric may be sufficient for small containers, while large containers may utilize fabric up to about thirty ounces. While common sizes are, for example, three gallon, five gallon and ten gallon, fabric containers may range in size from a quart-sized container to one hundred gallons or larger. The weight and thickness of the fabric of container 5 will be less than the weight and thickness of production fabric 16 prior to forming container 5. The decrease in weight and thickness is a result of the manufacturing process described herein. Thus, for example, an eight-ounce fabric may be needed to produce an end product container with a four-ounce fabric, and a fifty-ounce production fabric may be needed to produce an end product container 5 with a fabric weight of thirty ounces.

In the embodiment shown, the base and binder fibers are non-continuous, non-woven fibers. It is understood, however, that such fibers may be non-continuous or continuous and may be woven or non-woven. Production fabric 16 may be formed with the base fibers and the binder fibers using needle-punching. Needle-punching machines operate by inserting large numbers of needles at a high speed through the fibers. Needle-punching fibers to create fabric is generally known. The base and binder fibers of different materials can be blended, aligned and placed to form a layer of fibers of desired thickness. The layer of fibers is passed through the needle punch machine and the needles interact with the fibers so that the fibers become increasingly tangled and knotted, thereby joining the base and binder fibers to create the production fabric 16.

In a pot or container 5 provided by the present disclosure, the roots of a plant grow outward and attempt to grow through the porous, needle-punched production fabric comprising the container pot. Because of the fuzzy inner surface 11 and tangled and dense network of fibers, the roots partially grow through the fabric but become choked off, thereby preventing continued growth of the roots and therefore also preventing or at least greatly reducing root circling. When a root is entangled and chocked off, root pruning will occur. Because container 5 is porous and permeable, many roots will go through the fabric and reach the air. These roots will be air-pruned, meaning they will stop growing at the tip of the root where the root has hit the air, and will initiate lateral root growth further back inside the container. In this way the container will root prune the root structure of the plant. In addition, the container 5 will release heat which also promotes the growth of healthy plants. Plastic, tin and other hard-sided, non-porous containers hold and retain heat, which can prevent healthy plant growth. The porous, permeable fabric of the container 5 provides for the release of heat, thus providing for a healthier growth environment.

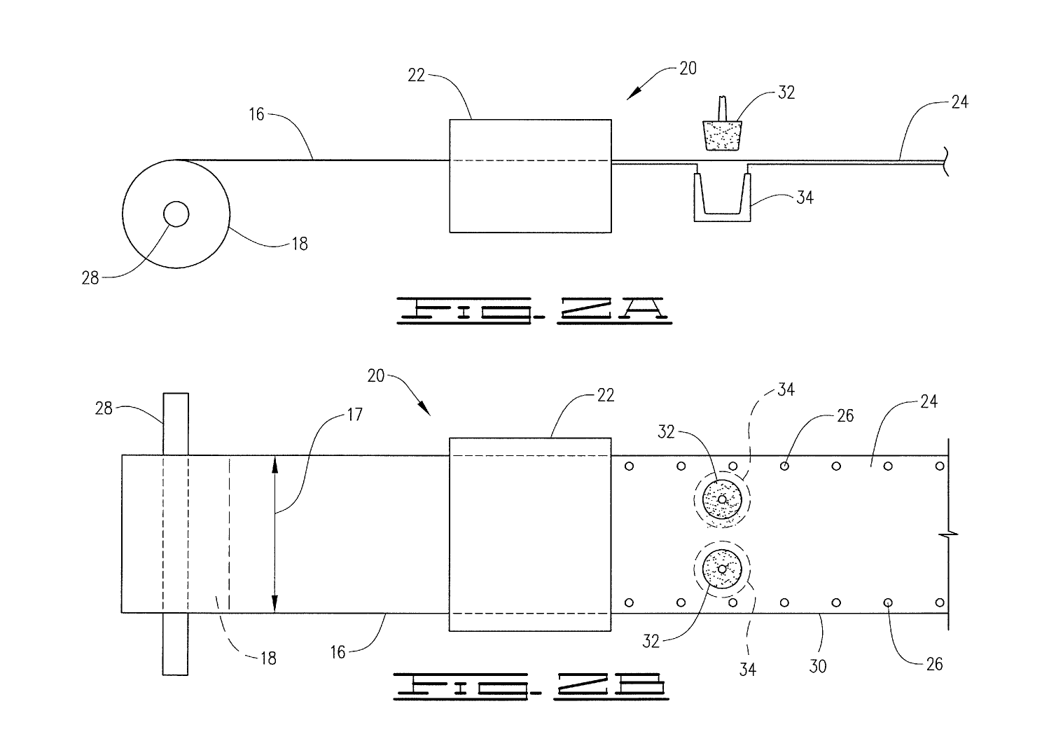

Turning to FIG. 2A, a method for manufacturing the present fabric pots is illustrated. The method shown comprises utilizing a roll 18 of production fabric 16. Production fabric 16 can be arranged in a roll 18 or any other arrangement suitable to provide fabric for movement along a conveyor type or an assembly line type of operation. FIGS. 2A and 2B schematically show a conveyor system 20 that includes a drive apparatus 22 that will pull production fabric 16 from roll 18, and will move a conveyor 24 to which production fabric 16 can be attached with pins or other fastening devices 26. Production fabric 16 may be placed on reel 28 and connected with fastening devices 26 at the edges 30 thereof to conveyor 24. Once production fabric 16 is pinned, conveyor 24 can move the production fabric 16 until it is positioned beneath plungers 32. The embodiment described illustrates an embodiment with a plurality of plungers 32 spaced across a width 17 of production fabric 16. It is understood that a single plunger 32, or any desired number of spaced-apart plungers may be used. The spacing between plungers must be such as to allow production fabric 16 to stretch and fit around plungers 32. If a sheet of small containers is desired, a plurality of plungers and molds can be utilized so that the result is a sheet of small containers, which would have the appearance of, for example, a muffin or cupcake pan.

Plungers 32 are positioned above production fabric 16 and may be configured to press down on the production fabric 16 and to stretch the production fabric into the desired shape. A mold 34 will be positioned beneath each plunger 32. Mold 34 may be formed of a plurality of moveable pieces that are actuated to close around plunger 32. Alternatively, mold 34 can simply be configured such that it closely receives the plunger 32 with production fabric 16 thereabout. Plunger 32 will normally be at room temperature prior to stretching production fabric 16 and pushing production fabric 16 into mold 34. Plunger 32 pressing the production fabric 16 into the shape of container 5 causes production fabric 16 to stretch and therefore decrease in weight and thickness. Generally, the weight of the production fabric 16 will decrease by about half after being stretched into the shape of the container 5. Therefore, the weight and thickness of production fabric 16 must be selected in view of the desired final weight and thickness of container 5. Additionally, the density of container 5 can impact the permeability and rigidity thereof. In all cases, the end product will be porous and permeable.

Once plunger 32 presses production fabric 16 into mold 34 heat is applied until the production fabric 16 reaches a temperature above the melting point of the binder fiber but below the melting point of the base fiber. As a result, production fabric 16 will become flexible but will not fully melt or plasticize. Plunger 32 is retracted after the desired temperature is reached, and if an openable mold is used the mold is opened, and conveyor 24 is activated to move the formed container 5 from beneath the plunger 32 area, and to move the next portion production fabric 16 to the plunger area. Plungers 32 and molds 34 can take any desired shape, depending on the intended final shape of container 5. Production fabric 16 will adopt the shape of the plunger 32 and mold 34. Thus, both mold 34 and plunger 32 should be configured so that the final shape of container 5 is a desired shape, for example, the frustoconical shape described herein. Once the formed container 5 has cooled, it can be cut from the rest of production fabric 16. Although the embodiment shown in FIGS. 2A and 2B uses mold 34 to heat the production fabric 16, other methods of heating the production fabric 16 can be used. For example, radiation can be used to heat the production fabric 16 and a vacuum used to hold the fabric tightly against plunger 32. In addition, mold 34 can be preheated if desired so that production fabric 16 is heated immediately upon being inserted into mold 34.

Because production fabric 16 has been heated above the melting temperature of the binder fabric, the production fabric readily stretches and adopts the shape of plunger 32. For example, if the melting point of the binder fiber is 200° F., and the melting point of the base fiber is 295° F., heat is applied until a temperature therebetween is reached.

Turning to FIG. 2B, a top-down view of the illustration in 2A is provided. FIG. 2B illustrates that a plurality of plungers 32 can be used simultaneously with the production fabric 16. Although FIG. 2B illustrates two plungers 32 being used simultaneously, three, four or more plungers 32 can be used simultaneously. The number of plungers 32 used can depend on a variety of factors including the width of the production fabric 16 and the desired shape and size of the finished containers to be produced.

Additionally, FIG. 2B illustrates that the production fabric 16 may have one or more fastening devices 26 to restrain edges 30 of production fabric 16 and prevent production fabric 16 from sliding, or gathering into mold 34, and instead will stretch as described herein.

Thus, the current disclosure provides a self-supporting fabric plant container that needs no additional support structure. The plant container will stand upright on its own and will provide for a rigid enough container that can be utilized in assembly lines and other automated pot-filling systems. The plant container will stand upright such that soil or other plant-growing medium may be poured directly through the open top thereof. The method described herein provides for a fabric plant container comprised of a single piece of fabric with no stitching or sewing or other joints.

Thus, it is seen that the apparatus and methods of the present invention readily achieve the ends and advantages mentioned as well as those inherent therein. While certain preferred embodiments of the invention have been illustrated and described for purposes of the present disclosure, numerous changes in the arrangement and construction of parts and steps may be made by those skilled in the art, which changes are encompassed within the scope and spirit of the present invention.

What is claimed is:

1. A plant container comprising:
a fabric bottom: and
a fabric sidewall extending upwardly from the fabric bottom, the fabric sidewall being porous and having sufficient rigidity to stand upright, wherein the bottom and sidewall are formed from a single piece of fabric.

2. The plant container of claim 1, the single piece of fabric comprising a plurality of base fibers and binder fibers, wherein the binder fiber has a lower melting point than the base fiber.

3. The plant container of claim 1, the single piece of fabric comprising a mix of base and binder fibers, wherein the base fibers and binder fibers are both polymers.

4. The plant container of claim 3 wherein the base fibers are selected from the group consisting of polyethylene, polypropylene, polyvinylchloride, polystyrene, polyolefins, polyamide, polyurethane, polyester and mixtures thereof.

5. The plant container of claim 3, wherein the base fibers are polyester fibers.

6. The plant container of claim 3, wherein the binder fibers comprise a bi-component polyester.

7. The plant container of claim 1, comprising a generally frustoconical shape.

8. The plant container of claim 1, wherein the fabric container is air and water permeable.

9. A method of manufacturing a rigid fabric container comprising:
fabricating a generally flat fabric sheet;
forming a container shape with an open top from the fabric sheet;
heating the container shape;
cooling the container shape; and
cutting the container shape from the fabric sheet.

10. The method of claim 9, the forming step comprising:
inserting a portion of the fabric sheet into a mold with a plunger; and
removing the plunger after the heating step.

11. The method of claim 10 wherein the fabricating step comprises needle-punching base fibers and binder fibers into the generally flat fabric sheet.

12. The method of claim 11, wherein the base fibers have a higher melting point than the binder fibers.

13. The method of claim 10, wherein the rigid fabric container conforms to the shape of the plunger.

14. The method of claim 10 further comprising stretching the fabric sheet during the forming step.

15. The method of claim 10 further comprising providing at least two plungers and simultaneously plunging at least two separate portions of the fabric sheet into at least two molds with the at least two plungers to faun at least two container shapes, and conducting the heating, removing, cooling and cutting steps for each container shape.

16. A plant container comprising:
a fabric bottom;
a fabric sidewall connected to and extending upwardly from the bottom, the sidewall defining an open top, wherein the fabric is comprised of base and binder fibers, the binder fibers having a lower melting point than the base fibers.

17. The plant container of claim 16, wherein the plant container is rigid such that it will stand upright with no other supporting structure.

18. The plant container of claim 17, wherein the plant container is formed from a single piece of fabric with no stitching.

19. The plant container of claim 16, wherein the base and binder fibers are polymers.

20. The plant container of claim 16, wherein the inner surface of the sidewall is configured to trap the roots of a plant grown therein.

21. The plant container of claim 16, wherein the fabric sidewall is configured to trap roots and initiate root pruning.

22. The plant container of claim 16, wherein the fabric sidewall is configured to reduce root circling in the container.

23. The plant container of claim 16 wherein the fabric sidewall is constructed to release heat.
